(19) United States
(12) Patent Application Publication
(10) Pub. No.: US 2013/0264083 A1
(43) Pub. Date: Oct. 10, 2013

(54) CARRIAGE ASSEMBLY FOR A GROUND ENGAGING IMPLEMENT

(71) Applicants: John E. Jorgensen, Andover, MN (US); Todd E. Moser, Roanoke, IL (US)

(72) Inventors: John E. Jorgensen, Andover, MN (US); Todd E. Moser, Roanoke, IL (US)

(73) Assignee: Caterpillar Inc., Peoria, IL (US)

(21) Appl. No.: 13/441,969

(22) Filed: Apr. 9, 2012

(51) Int. Cl. E02F 3/04; E02F 3/76; E02F 5/32; A01B 13/08

(52) U.S. Cl. 172/830; 172/663; 172/292

(57) ABSTRACT

A carriage assembly for a ground engaging implement is provided. The carriage assembly includes a carriage, a ground engaging implement, and a cylinder. The ground engaging implement is pivotally connected to the carriage. The ground engaging implement has a longitudinal face. The cylinder is connected to the carriage and includes a cylinder housing, a compressible medium, and a rod. The compressible medium is contained within the cylinder housing. The rod extends outward from the cylinder housing. The rod has a piston portion at one end and an engagement surface at another end. The engagement surface is positioned at a contactable distance from the longitudinal face of the ground engaging implement.

### TECHNICAL FIELD

The present disclosure relates to a carriage assembly, and more particularly to an impact absorbing and distributing assembly for a ground engaging implement, such as a ripper.

### BACKGROUND

A machine, such as, a track-type tractor is employed in various operations, such as, to loosen or to break ground surfaces. For example, the track-type tractor having a ripper supported by a carriage is pushed through the ground surface with sufficient force, and thereafter moved along the ground surface to either loosen or to break the ground surface. There may be instances when the ripper may come in contact with hard object, such as rock, present in the ground surface causing the ripper to encounter substantial impact. The impact encountered by the ripper may cause damage to a tip portion of the ripper, and/or impart significant stress to the associated structures of the ripper. For example, the carriage may impart stress on tilt cylinders which are coupled to the carriage for controlling a pitch or attack angle of the ripper. Therefore, repeated severe impact experienced by the ripper may adversely affect the integrity of the associated structures, the carriage, and the ripper.

U.S. Pat. No. 6,311,784 discloses a ripper carriage assembly that includes a ripper implement support housing having a predefined longitudinal axis, a first end portion having a pivotal connection adapted for attachment to a lift mechanism, and a second end spaced from the first end. The ripper carriage assembly further includes a transverse cross beam spaced from the longitudinal axis of the support housing and extending in a direction transverse to the longitudinal axis. The transverse cross beam has a central portion rigidly mounted on the second end portion of the support housing, and a pair of arms extending respectively outwardly from the middle portion. Each of the arms has a distal end and a stress relief notch formed at a position between the distal end of the arm and the middle portion of the transverse cross beam.

### SUMMARY OF THE DISCLOSURE

In one aspect, the present disclosure provides a carriage assembly for a ground engaging implement. The carriage assembly includes a carriage, a ground engaging implement, and a cylinder. The ground engaging implement is pivotally connected to the carriage. The ground engaging implement has a longitudinal face. The cylinder is connected to the carriage and includes a cylinder housing, a compressible medium, and a rod. The compressible medium is contained within the cylinder housing. The rod extends outward from the cylinder housing. The rod has a piston portion at one end and an engagement surface at another end. The engagement surface is positioned at a contactable distance from the longitudinal face of the ground engaging implement.

Other features and aspects of this disclosure will be apparent from the following description and the accompanying drawings.

### BRIEF DESCRIPTION OF THE DRAWINGS

FIG. 1 illustrates a side view of an exemplary machine, according to one embodiment of the present disclosure; and

FIG. 2 illustrates an enlarged cross-sectional view of a portion of the machine, showing a carriage, a ground engaging implement, and a carriage assembly for the ground engaging implement.

### DETAILED DESCRIPTION

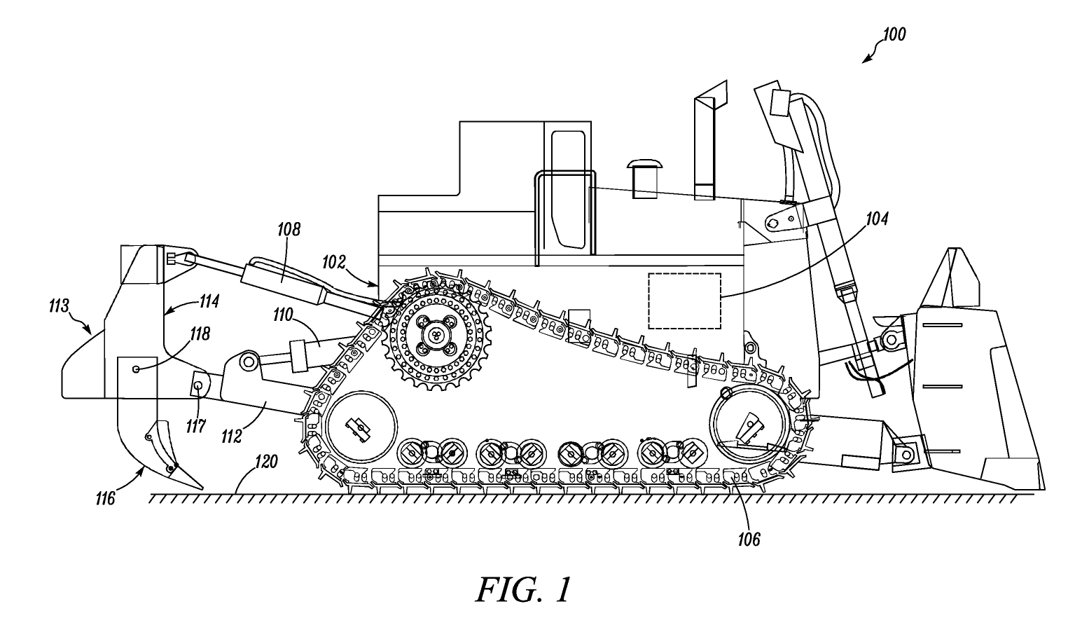

The present disclosure will now be described in detail with reference being made to accompanying figures. An exemplary machine 100 in which disclosed embodiments may be implemented is schematically illustrated in FIG. 1. In the accompanied drawings, the machine 100 is illustrated as a track-type tractor. However, the machine 100 may be any earth moving machine, such as a tractor, loader, excavator or motor grader used in various industries such as agriculture, mining, waste management, or construction.

The machine 100 includes a frame 102 and an engine 104 carried by the frame 102. The machine 100 also includes a traction device 106, such as tracks, mounted on the frame 102. Alternatively, the traction device 106 may include wheels mounted on the frame 102. The traction device 106 is operatively coupled to receive a driving force from the engine 104 for providing movement to the frame 102.

The machine 100 further includes one or more actuators, such as first and second tilt cylinders 108, 110 and a support member 112, pivotally connected to the frame 102. The machine 100 also includes a carriage assembly 113. The carriage assembly 113 includes a carriage 114 coupled with the actuators, i.e. the first and second tilt cylinders 108, 110 and the support member 112. The carriage 114 is adapted to support a ground engaging implement 116.

The ground engaging implement 116 shown in FIG. 1 is a ripper. Alternatively, the ground engaging implement 116 may be any other ripping implement, like a blade. The ground engaging implement 116 is pivotally coupled with the carriage 114 by a pin 118 extending through the ground engaging implement 116 and the carriage 114. The ground engaging implement 116 is adapted to pivot about the pin 118 with a limited movement within the carriage 114 during operation. The carriage assembly 113 is adapted to absorb and distribute an impact encountered by the ground engaging implement 116 during operation.

The ground engaging implement 116 is controlled by the actuators, i.e. the first and second tilt cylinders 108, 110 and the support member 112. Specifically, the actuators facilitate in moving, and controlling a pitch or attack angle of the ground engaging implement 116 with respect to a ground surface 120.

As illustrated in FIG. 1, the first tilt cylinder 108 is pivotally connected between the frame 102 and an upper portion of the carriage 114. The support member 112 is pivotally connected between the frame 102 and a lower portion of the carriage 114 at a pivot point 117. The second tilt cylinder 110 is pivotally coupled between the frame 102 and an intermediate portion of the support member 112.

The second tilt cylinder 110 facilitates in lifting and lowering the carriage 114 along with the ground engaging implement 116. Specifically, when the second tilt cylinder 110 extends, the support member 112 is lowered, thereby lowering the carriage 114 with the ground engaging implement 116. Further, when the second tilt cylinder 110 retracts, the support member 112 is raised, thereby raising the carriage 114 with the ground engaging implement 116.

The first tilt cylinder 108 facilitates in controlling the pitch of the ground engaging implement 116 with respect to the ground surface 120. Specifically, when the first tilt cylinder 108 extends or retracts the carriage 114 pivots about the pivot point 117. The pivotal movement of the carriage 114 changes the pitch of the ground engaging implement 116 with respect to the ground surface 120. It should be understood that the machine 100 may include any arrangement of actuators, wherein at least one of the actuators is used for lifting and lowering the carriage 114 and the ground engaging implement 116; and also used to control the pitch of the ground engaging implement 116.

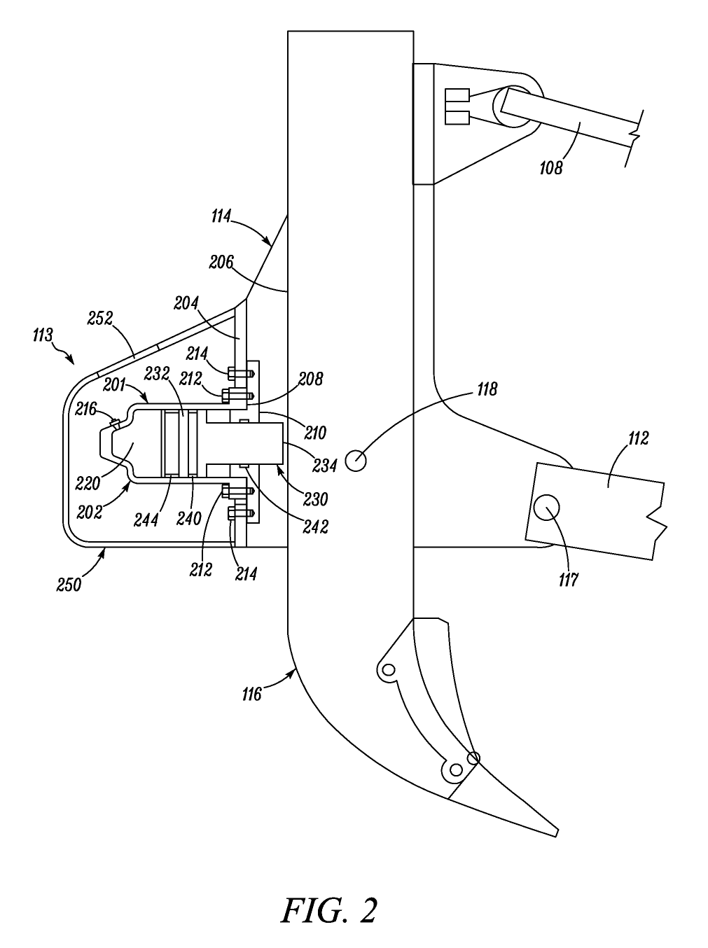

Referring now to FIG. 2, the carriage assembly 113 includes a cylinder 201 connected to the carriage 114 and positioned in proximity to the ground engaging implement 116. Specifically, the cylinder 201 is coupled to a rear face 204 of the carriage 114 such that the cylinder 201 is positioned perpendicularly adjacent to a longitudinal face 206 of the ground engaging implement 116. It should be understood that the cylinder 201 may be configured to have various sizes based on an impact absorbing and distributing limit of the carriage assembly 113 or varied by the machine 100 to meet performance objectives. Additionally, the cylinder 201 may be configured to have a cross-section of either a polygonal shape, a circular shape, or an oval shape.

The cylinder 201 includes a cylinder housing 202 having a rod end 208 coupled to the carriage 114. Specifically, the cylinder housing 202 includes a mounting plate 210 that facilitates coupling the rod end 208 with the carriage 114. The mounting plate 210 may be a polygonal or a circular plate type structure having a projected portion conforming to the rod end 208 of the cylinder 201. The projected portion includes a central opening.

The rod end 208 of the cylinder housing 202 may be coupled to the mounting plate 210 using bolts 212, and the mounting plate 210 may be coupled to the carriage 114 using bolts 214. Accordingly, the cylinder housing 202 is adapted to be removably coupled with the rear face 204 of the carriage 114. However, it may be evident to those skilled in the art that, the cylinder housing 202 may be coupled to the carriage 114 by other suitable coupling means or method, such as welding.

A compressible medium 220 is contained within the cylinder housing 202. In one embodiment, the compressible medium 220 may be a compressible fluid, such as nitrogen gas or liquid silicon. In the present embodiment, the compressible medium 220 is nitrogen gas. In another embodiment, a belleville spring (not shown), or any other combination of elements as known in the art may be utilized within the cylinder housing 202. It should be understood that when the compressible medium 220 includes the compressible fluid, the cylinder housing 202 may be configured with a charging valve 216 for filling the compressible medium 220 into the cylinder housing 202.

The cylinder 201 also includes a rod 230 movably extending outwards from the cylinder housing 202. The rod 230 includes a piston portion 232 at one end and an engagement surface 234 at another end. The piston portion 232 is received within the cylinder housing 202. The engagement surface 234 is partially extending from the cylinder housing 202 through the central opening of the mounting plate 210. Further, the engagement surface 234 is positioned at a contactable distance from the longitudinal face 206 of the ground engaging implement 116 to provide desired recoil for the carriage assembly 113.

The carriage assembly 113 further includes circumferential seals provided between the cylinder housing 202 and the rod 230 for providing a fluid tight interaction therebetween. For example, a seal 240 may be received in a slot configured on the piston portion 232 of the rod 230. Further, the seal 240 may be allowed to contact an inner surface of the cylinder housing 202. Moreover, another seal 242 may be received in a slot configured on the mounting plate 210, and the seal 242 may be allowed to contact an outer surface of the rod 230. It may be evident to those skilled in the art that the number of seals and the position thereof may be altered in order to attain the fluid tight interaction between the cylinder housing 202 and the rod 230.

The carriage assembly 113 also includes a wear band 244 provided between the cylinder housing 202 and the rod 230 for providing low friction and high wear life to the rod 230. In the present embodiment, the wear band 244 may be received in a slot, configured adjacent to the slot receiving the seal 240, on the piston portion 232 of the rod 230. Further, the wear band 244 may be allowed to contact the inner surface of the cylinder housing 202.

The carriage assembly 113 further includes an enclosure 250 for covering the cylinder 201. The enclosure 250 is coupled to the rear face 204 of the carriage 114. For example, the enclosure 250 may be welded to the rear face 204 of the carriage 114 for covering the cylinder 201 therein. Further, the enclosure 250 may be provided with an opening 252 for accessing the cylinder 201. For example, the cylinder 201 may be accessed for charging and servicing purposes. In one embodiment, the enclosure 250 may also be used as a push block.

### INDUSTRIAL APPLICABILITY

The present disclosure provides the machine 100 with the carriage assembly 113 for absorbing and distributing impact encountered by the ground engaging implement 116, such as the ripper, due to low frequency high magnitude system loading. The term “impact” used herein may be referred to peak loads observed by the ground engaging implement 116 when the ground engaging implement 116 hits any hard object, such as rock. The machine 100 may typically be used for operations like loosening or breaking the ground surface 120. The machine 100 is particularly suited for applications such as roadway construction and site preparation.

During operation of the machine 100, the ground engaging implement 116 may be pushed through the ground surface 120 with sufficient force and thereafter moved along the ground surface 120 to either loosen or to break the ground surface 120. There may be instances when the ground engaging implement 116 may come in contact with a sudden hard object, causing the ground engaging implement 116 to encounter an impact.

The impact encountered by the ground engaging implement 116 may cause damage to a tip portion of the ground engaging implement 116. Additionally, the impact may adversely affect the integrity of the associated structures, such as the first and second tilt cylinders 108, 110, the support member 112, the carriage 114 associated with the ground engaging implement 116 and other parts of the machine 100.

In the present disclosure, when the ground engaging implement 116 experiences the impact, the carriage assembly 113 facilitates in absorbing and distributing the impact. As disclosed above, the positioning of the carriage assembly 113 is such that the longitudinal face 206 of the ground engaging implement 116 is forced against the engagement surface 234 of the rod 230 when the ground engaging implement 116 encounters the impact. It should be understood that during normal operation, the force transferred from the longitudinal face 206 of the ground engaging implement 116 may not be sufficient to compress the rod 230 within the cylinder 201.

When the ground engaging implement 116 encounters the impact, the ground engaging implement 116 may pivot about the pin 118 and the longitudinal face 206 of the ground engaging implement 116 may contact the engagement surface 234 of the rod 230. The magnitude of this impact force may be based on system sizing. The contact of the ground engaging implement 116 and the engagement surface 234 advances the rod 230 inside the cylinder housing 202. The movement of the rod 230 moves (compresses) the compressible medium 220 to absorb the impact from the ground engaging implement 116. Hence, the engagement surface 234 is configured to absorb the impact through the compressible medium 220 contained within the cylinder housing 202.

Specifically, the piston portion 232 of the rod 230 advances within the cylinder housing 202 for compressing the compressible medium 220. Therefore, energy of the impact is received by the compressible medium 220 and stored by the compressible medium 220 in the compressed state thereof.

The compressible medium 220 may include a charged-level for defining a stroke length of the rod 230 within the cylinder housing 202. The term “charged-level” is used herein to define a compressibility limit of the compressible medium 220. For example, when the compressible medium 220 is the compressible fluid (nitrogen gas or liquid silicon), the charged-level may be defined by a pressure of the compressible medium 220 inside the cylinder housing 202. Based on the pressure of the compressible medium 220, the rod 230 within the cylinder housing 202 may have a different actuation force to advance the rod 230. For example, a high pressure of the compressible medium 220 may provide a small stroke length for the rod 230 within the cylinder housing 202 for a given force, and similarly a low pressure of the compressible medium 220 may provide a comparatively longer stroke length for the rod 230 within the cylinder housing 202 for the same given force. The charge pressure may be used to set the cut-off point for the force transferred through the carriage 114.

Further, the charging valve 216 may be used for filling the compressible medium 220 into the cylinder housing 202, and thereby regulate the pressure of the compressible medium 220 within the cylinder housing 202. It may be evident to those skilled in the art that, when the belleville spring is used inside the cylinder 201, the charged-level may be defined by stiffness of the belleville spring. Therefore, the charged-level of the belleville spring may be altered by varying the stiffness of the compressible medium 220.

The ground engaging implement 116 may attain a fixed state when the carriage assembly 113 reaches a limit for absorbing and distributing the impact. For example, the carriage assembly 113 may offer a hard-stop to the ground engaging implement 116. Specifically, when the given recoil distance of the engagement surface 234 to the mounting plate 210 is reached, the longitudinal face 206 of the ground engaging implement 116 may contact the mounting plate 210 of the cylinder 201. Thus, the rod 230 may stop advancing inside the cylinder housing 202, and the ground engaging implement 116 may attain the fixed state.

It is to be understood that the impact absorbing and distributing limit for the carriage assembly 113 may be defined by at least a size of the cylinder 201 and the charged-level of the compressible medium 220. Additionally, properties, such as density, of the compressible medium 220 (nitrogen gas or liquid silicon) may also play an important role in defining the impact absorbing and distributing limit of the carriage assembly 113.

In the compressed state, the compressible medium 220 may absorb the impact encountered by the ground engaging implement 116 and thereafter distribute the absorbed impact over a time period to the ground engaging implement 116 and the associated structures. The associated structures may include the carriage 114 and the actuators, i.e. the first and second tilt cylinders 108, 110 and the support member 112.

A person of ordinary skill in the art will appreciate that the distribution of the absorbed impact occurs when the compressible medium 220 starts pushing the rod 230 out of the cylinder housing 202. For example, when the impact finishes, the compressible medium 220 tends to expand and push the rod 230 out of the cylinder housing 202. Specifically, the energy stored in the compressible medium 220 is released for slidably moving the rod 230 out of the cylinder housing 202. Accordingly, the engagement surface 234 of the rod 230 may push the longitudinal face 206 of the ground engaging implement 116. This allows in transmitting the energy (generated by the impact) of the compressible medium 220 to the ground engaging implement 116 and the associated structures.

The absorption and distribution of the impact in such a manner provides substantial wear and tear resistance to the ground engaging implement 116. For example, the tip portion of the ground engaging implement 116 may be protected from wear and tear by absorbing and distributing the impact encountered by the ground engaging implement 116. Additionally, the absorption and distribution of the impact may facilitate in substantially reducing stresses, which may occur in connecting portions of the ground engaging implement 116 and the associated structures. This may provide structural integrity to the ground engaging implement 116 and the associated structures. Moreover, the carriage assembly may potentially minimize damage to the machine 100 from abusive environments and operations.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A carriage assembly for a ground engaging implement, comprising:
a carriage;
a ground engaging implement pivotally connected to the carriage, the ground engaging implement having a longitudinal face; and
a cylinder connected to the carriage, the cylinder including:
a cylinder housing;
a compressible medium contained within the cylinder housing; and
a rod extending outward from the cylinder housing, the rod having a piston portion at one end and an engagement surface at another end, wherein the engagement surface is positioned at a contactable distance from the longitudinal face of the ground engaging implement.

2. The carriage assembly of claim 1 further including an enclosure for covering the cylinder, wherein the enclosure includes an opening to provide access to the cylinder.

3. The carriage assembly of claim 1 further including a seal provided between the cylinder housing and the rod, the seal configured to provide a fluid tight interaction between the cylinder housing and the rod.

4. The carriage assembly of claim 1 further including a wear band provided between the cylinder housing and the rod, the wear band configured to provide low friction and high wear life to the rod.

5. The carriage assembly of claim 1, wherein the cylinder further includes a mounting plate, the mounting plate is adapted to mount the cylinder to the carriage.

6. The carriage assembly of claim 1, wherein at least a size of the cylinder and a charged-level of the compressible medium defines an impact absorbing and distributing limit for the carriage assembly.

7. The carriage assembly of claim 1, wherein the longitudinal face of the ground engaging implement is forced against the engagement surface of the rod, the engagement surface configured to absorb an impact through the compressible medium, when the ground engaging implement encounters the impact.

8. The carriage assembly of claim 1, wherein the compressible medium is one of nitrogen gas and liquid silicon.

9. The carriage assembly of claim 1, wherein the ground engaging implement is one of a ripper and a blade.

10. The carriage assembly of claim 1, wherein the cylinder is connected to the carriage by bolts.

11. A machine comprising:
a frame;
an engine carried by the frame;
a traction device mounted on the frame, the traction device operatively coupled to receive a driving force from the engine to provide movement to the frame;
an actuator pivotally connected to the frame;
a carriage coupled to the actuator;
an ground engaging implement pivotally connected to the carriage, the ground engaging implement having a longitudinal face; and
a cylinder connected to the carriage, the cylinder including:
a cylinder housing;
a compressible medium contained within the cylinder housing; and
a rod extending outward from the cylinder housing, the rod having a piston portion at one end and an engagement surface at another end, wherein the engagement surface is positioned at a contactable distance from the longitudinal face of the ground engaging implement.

12. The machine of claim 11 further including an enclosure for covering the cylinder, wherein the enclosure includes an opening to provide access to the cylinder.

13. The machine of claim 11 further including a seal provided between the cylinder housing and the rod, the seal configured to provide a fluid tight interaction between the cylinder housing and the rod.

14. The machine of claim 11 further including a wear band provided between the cylinder housing and the rod, the wear band configured to provide low friction and high wear life to the rod.

15. The machine of claim 11, wherein the cylinder further includes a mounting plate, the mounting plate is adapted to mount the cylinder to the carriage.

16. The machine of claim 11, wherein at least a size of the cylinder and a charged-level of the compressible medium defines an impact absorbing and distributing limit for the carriage assembly.

17. The machine of claim 11, wherein the longitudinal face of the ground engaging implement is forced against the engagement surface of the rod, the engagement surface configured to absorb an impact through the compressible medium, when the ground engaging implement encounters the impact.

18. The machine of claim 11, wherein the compressible medium is one of nitrogen gas and liquid silicon.

19. The machine of claim 11, wherein the ground engaging implement is one of a ripper and a blade.

20. The machine of claim 11, wherein the cylinder is connected to the carriage by bolts.
